(19) United States
(12) Patent Application Publication
(10) Pub. No.: US 2025/0110300 A1
(43) Pub. Date: Apr. 3, 2025

(54) HIGH-POWER FIBER ARRAY ASSEMBLY HAVING BUILT-IN COOLING ARRANGEMENT

(71) Applicant: Molex, LLC, Lisle, IL (US)

(72) Inventors: Devinder Pal Singh Saini, Boise, ID (US); Donald Edward Russell, Parma, ID (US); Kenneth Duane Cantrell, Midvale, ID (US); Layne Michael Lafollette, Fruitland, ID (US)

(21) Appl. No.: 18/832,530

(22) PCT Filed: Feb. 22, 2023
(86) PCT No.: PCT/IB2023/051589

§ 371 Date: Jul. 24, 2024

Related U.S. Application Data
(60) Provisional application No. 63/313,998, filed on Feb. 25, 2022.

(51) Int. Cl. G02B 6/42

(52) U.S. Cl. CPC G02B 6/4268; G02B 6/4249; G02B 6/4296

(57) ABSTRACT

An optical fiber array assembly for high power applications includes a support structure, an optical fiber array, a plurality of end caps and a fluid conduit arrangement. The optical fiber array extends through the support structure and has a plurality of optical fibers extending in a common longitudinal direction. The plurality of end caps is arranged such that each of the end caps is attached to an end portion of one of the optical fibers. The fluidic conduit arrangement has one or more conduits extending through the support structure. The one or more conduits are configured to support a flow of fluid therein to remove heat arising from optical energy back reflected from the end caps that enters the support structure.

### CROSS-REFERENCE TO RELATED APPLICATION

This application claims the benefit of U.S. Provisional Application Ser. No. 63/313,998, filed Feb. 25, 2022, the contents of which are incorporated herein by reference.

### BACKGROUND

There is an ever-increasing demand for high optical power to be delivered via optical fiber arrays for multiple applications such as laser cutting and welding, additive manufacturing, directed energy weapons, and so on. Due to the high power of the light transmitted in these systems, along with reflections from the various optical elements and stray light energy, there is heat buildup in the fiber optic assemblies. This heat needs to be reduced and dissipated so that the optical fiber array performs efficiently and is not damaged.

### SUMMARY

In accordance with one aspect of the subject matter described herein, an optical fiber array assembly for high power applications includes a support structure, an optical fiber array, a plurality of end caps and a fluid conduit arrangement. The optical fiber array extends through the support structure and has a plurality of optical fibers extending in a common longitudinal direction. The plurality of end caps is arranged such that each of the end caps is attached to an end portion of one of the optical fibers. The fluidic conduit arrangement has one or more conduits extending through the support structure. The one or more conduits are configured to support a flow of fluid therein to remove heat arising from optical energy back reflected from the end caps that enters the support structure.

In another particular embodiment, the one or more conduits includes at least one channel formed in the support structure.

In yet another particular embodiment, the one or more conduits includes at least one tube extending through the support structure.

In another particular embodiment, the support structure includes an airgap positioned to receive the back reflected optical energy. The one or more conduits include a first conduit having a first conduit segment that extends across the plurality of optical fibers in the optical fiber array to thereby receive the back reflected optical energy as light and/or heat that enters the support structure through a sidewall defining the airgap.

In another particular embodiment, the first conduit segment extends across the plurality of optical fibers on a first side of the optical fiber array and the array assembly further includes a second conduit having a second conduit segment extending across the plurality of optical fibers on a second side of the optical fibers opposing the first side of the optical fiber array.

In another particular embodiment, the first and second conduits each have an input and output through which the fluid enters and exits, respectively.

In another particular embodiment, the sidewall of the airgap has an absorbent coating that absorbs the back reflected optical energy.

In another particular embodiment, the support structure is transparent to the back reflected optical energy and the fluid flowing in the one or more conduits includes an absorbing die that absorbs the back reflected optical energy.

In another particular embodiment, the optical fiber array assembly further includes a third conduit segment that extends across the plurality of end caps to remove optical energy back reflected from the end caps that enters the support structure from circumferential sidewalls of the end caps.

In another particular embodiment, the optical fiber array assembly further includes a closed loop conduit containing a fluid having an absorbing die therein that absorbs the back reflected optical energy. The closed loop conduit is located radially closer to the optical fibers than the first conduit such that heat absorbed by the closed loop conduit flows through the support structure to the first conduit.

In another particular embodiment, the support structure includes upper and lower support structures that mate with one another with the optical fiber array being located therebetween, the upper and lower support structures each including a corresponding notch that defines the airgap when the upper and lower support structures are mated to one another.

In another particular embodiment, the one or more conduits includes first and second conduits extending in the upper and lower support structure, respectively. The first and second conduits are arranged symmetrically with respect to one another about a mating surface where the upper and lower support structures meet.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic exploded perspective view of one example of a high-power fiber array assembly.

FIG. 2 shows the front face of the fiber array assembly shown in FIG. 1.

FIG. 3 shows a schematic of the optical energy propagating in one of the optical fibers and surrounding end cap employed in the high-power fiber array assembly.

FIGS. 4, 5 and 6 shows different views of one embodiment of the cooling channels that may be incorporated in the high-power fiber array assembly shown in FIG. 1 to mitigate the adverse effects of the heat.

FIGS. 7, 8 and 9 show different views of another embodiment of the high-power fiber array assembly in which one or more additional cooling channels are located above and/or below the fiber endcap to keep the endcap cool.

FIGS. 10-11 show different views of another embodiment of the high-power fiber array assembly in which the lower and upper cooling channels each have a closed loop cooling channel associated with it.

FIGS. 12 and 13 show different views of another embodiment of the high-power fiber array assembly in which the cooling conduits are formed from tubes hat extend through the support structure.

### DETAILED DESCRIPTION

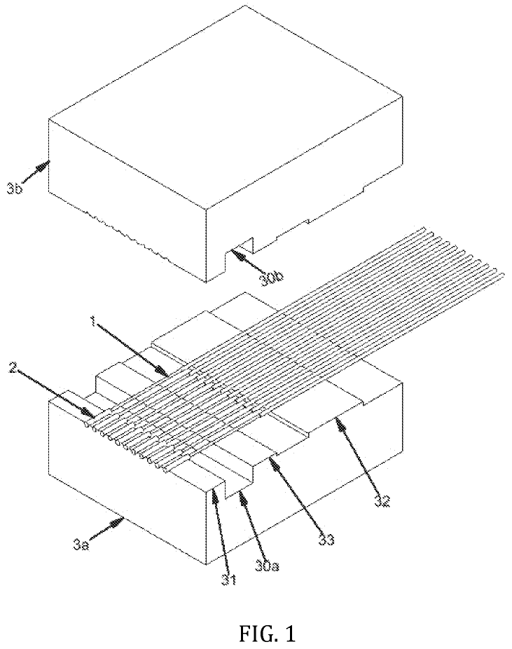

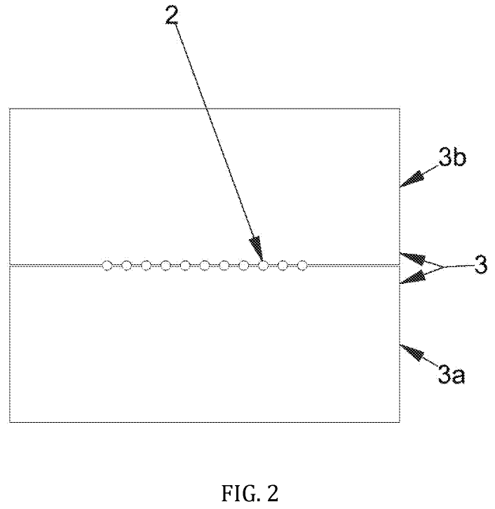

FIG. 1 shows a schematic exploded perspective view of one example of a high-power fiber array assembly in which cooling conduits such as channels or tubes may be incorporated to remove heat that can build up as a result of the high power that is employed. An array of optical fibers 1 is secured between a lower support structure 3a and an upper support structure 3b, which when mated together define a support structure 3. Fiber endcaps 2 are attached to the end portion of the optical fibers 1 from which light propagating in the optical fibers 1 exits. When the energy density becomes too high the end face of the fiber can be damaged and hence cause failure of the array. This damage occurs at the glass air interface. The fiber endcap 2, which can be fused to the optical fiber end face, mitigates this damage by allowing for a larger area for the light to exit, leading to a reduced energy density at the glass air interface and hence reducing or eliminating the damage caused to the optical fiber 1. FIG. 2 shows the front face of the fiber array assembly, with the fiber endcaps 2 visible between the lower and upper support structures 3a and 3b. It should be noted that in FIGS. 1 and 2 and the figures that follow, like elements are denoted by like reference numerals.

The optical fibers 1 are generally arranged in parallel to one another and extend in a longitudinal direction along the lower support structure 3a. The lower support structure 3a includes a notch 30a having a width in the longitudinal direction that is traversed by each of the optical fibers 1. The notch 30a is defined by sidewalls of ridges 31 and 33. A corresponding notch 30b is located in the upper support structure 3b.

The fiber endcaps 2 are supported by a ridge 31 and may be located in V-grooves defined therein. Likewise, the optical fibers 1 may be supported by ridges 32 and 33. In some cases a suitable adhesive such as an epoxy may be used to secure the endcaps 2 and the optical fibers 1 to the support structure. It should be noted that the optical fibers 1 are generally surrounded by a fiber jacket, which as seen in FIG. 1, has been removed in a region that includes where the optical fibers 1 traverse the width of the notch 30a.

The upper and lower support structures 3b and 3a can be formed from a wide range of different materials. Illustrative examples include glass, which may be transparent to the operating wavelengths of light used in the high-power fiber array assembly, as well as metals and metal alloys and the like.

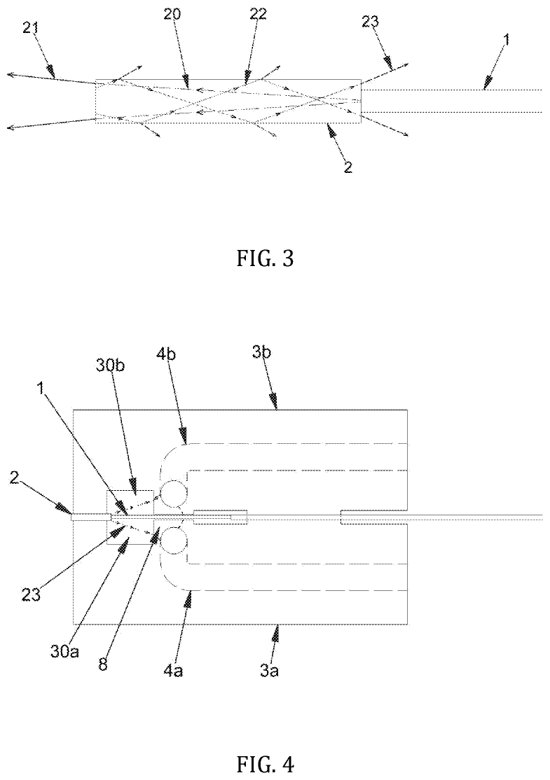

FIG. 3 shows in more detail the fiber endcap 2 surrounding the light emitting end of one of the optical fibers 1. As shown, light 20 propagates from the optical fiber 1 into the endcap 2 and exits the endcap 2 as light 21 that extends over a larger area relative to the light propagating in the optical fiber 1. Also shown is light 22 that is reflected back through the fiber endcap 2. The back reflected light 22 exits the fiber endcap 2 as light 23 at various points along the circumference of the endcap 2 as well as the entrance face where the optical fiber 1 meets the endcap 2. This light can be absorbed by the support structure and converted to heat, which is then contained within the fiber array assembly. However, as the power increases the fiber assembly gets hotter, leading to failures of the various components of the fiber array assembly such as the epoxies used to build it. The epoxies outgas particles which can end up on the end faces of the optics, leading to further failures.

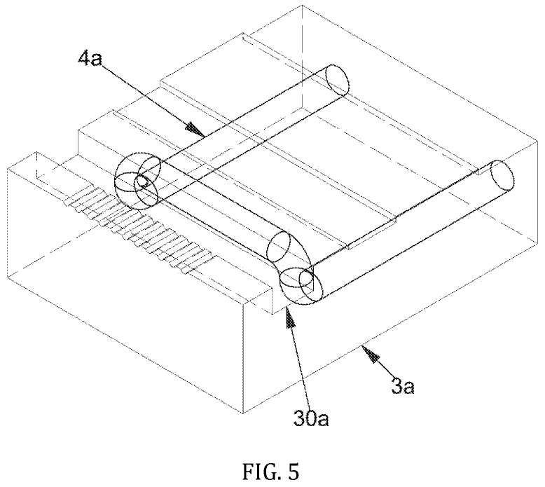

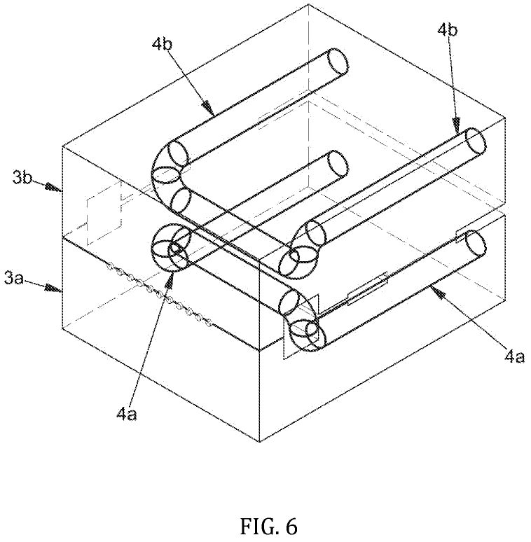

FIGS. 4, 5 and 6 shows one embodiment of the cooling channels that may be incorporated in the high-power fiber array assembly shown in FIG. 1 to mitigate the adverse effects of the heat. FIG. 4 is a side view in which the optical fibers 1 are arranged in a horizontal plane extending into the page. FIGS. 5 and 6 are perspective views of the fiber array assembly without and with the upper support structure 3b in place, respectively. As shown, a lower cooling channel 4a is formed in the lower support structure 3a and an upper cooling channel 4b is formed in the upper support structure 3b. The lower cooling channel 4a has inlet and outlet channel segments through which a cooling fluid (e.g., liquids such as distilled water or others with higher heat capacities, gasses such as nitrogen, etc.) respectively enters and exits the lower cooling channel 4a. In this example the inlet and output channel segments extend largely parallel to the optical fibers 1. A transverse channel segment is in fluidic communication with the inlet and outlet channel segments and extends across the array of optical fibers 1 and parallel to the sidewall of the notch 30a. That is, the inlet and output channel segments and the transverse channel segment form a continuous channel, with the transverse channel segment extending parallel to the sidewalls of the notch 30b. In the example shown in FIGS. 4 and 6, the upper cooling channel 4b is arranged in a symmetric manner with respect to the upper cooling channel, although this need not be the case. Moreover, in some embodiments only one of the lower and upper cooling channels 4a and 4b may be employed.

As best seen in the side view of FIG. 4, the reflected light 23 emanating from the fiber endcap 2 back toward the optical fiber 1 enters the airgap defined by the upper and lower notches 30b and 30a, where it is then absorbed by the sidewalls of the notches 30b and 30a defined in the upper and lower support structures as light and heat energy 8. The transverse channel segments are located in the support structure as close as practical to the air gap to thereby maintain structural integrity. In this way the transverse channel segments are able to absorb the light and/or heat 8 that enters the support structure after traversing the airgap.

In some embodiments an absorbent material may be coated on the sidewall of the upper and lower notches 30a and 30b to absorb the light reflected back from the fiber endcap 2. In an alternative embodiment, if the support structure is formed from a material such as glass that is transparent to the optical energy in the optical fibers, the cooling fluid in the cooling conduits may include an absorbing die to absorb the reflected light that enters the support structure.

In some embodiments, the cooling channels 4a and 4b may have a diameter that ranges from a fraction of a millimeter up to several millimeters, depending on a variety of factors includes the number and size of the optical fibers in the array and the amount of power to be transmitted through them. In general, the diameter of the cooling channels will be greater than the diameter of the optical fibers, which in some typical high power applications may range from hundreds of microns to upwards of a millimeter. The cooling channels may be formed by any suitable technique such as laser etching with the use of a femtosecond laser or by a 3D printing technique that may be used to form the support structure.

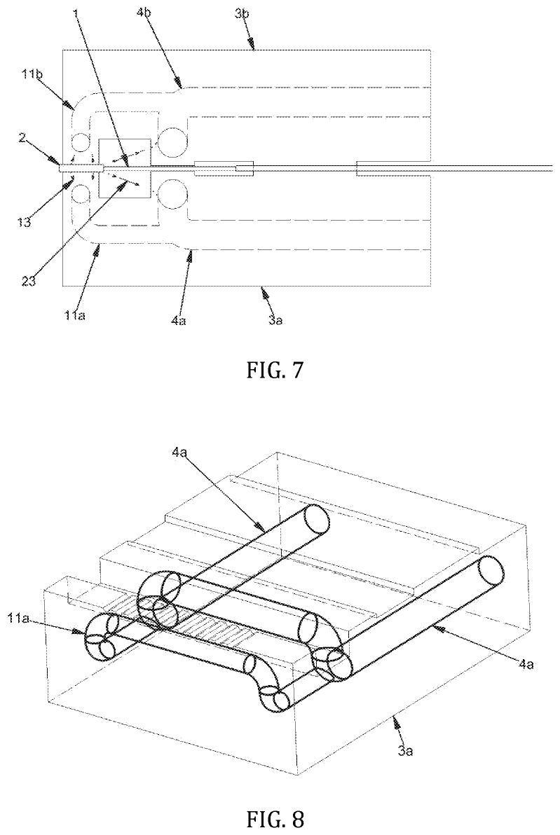

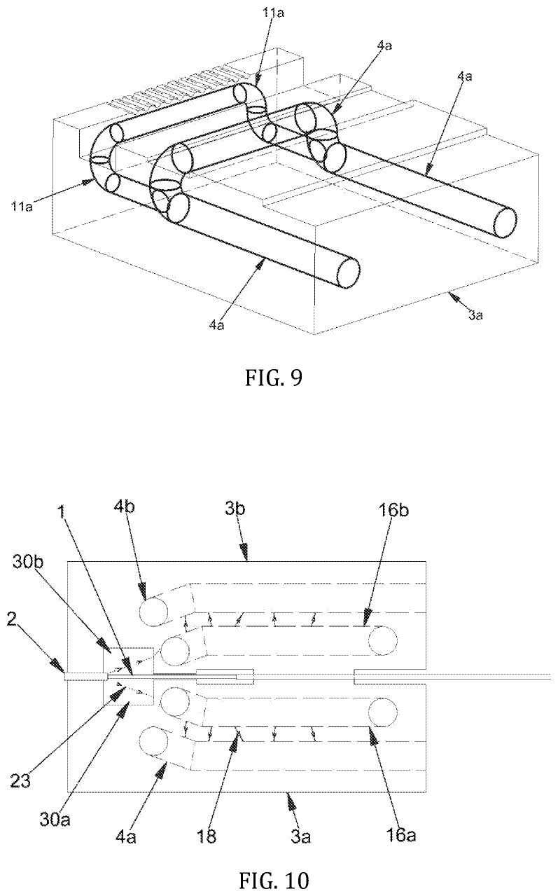

FIGS. 7-9 show another embodiment of the high-power fiber array assembly in which one or more additional cooling channels are located above and/or below the fiber endcap 2 to keep the endcap 2 cool. The additional cooling channels can cool the fiber endcaps 2 by receiving light and heat 13 exiting the circumference of the fiber endcaps 2. FIG. 7 is a side view in which the optical fibers 1 are arranged in a horizontal plane extending into the page. FIGS. 8 and 9 are two different perspective views of the fiber array assembly without the upper support structure 3b in place. In this embodiment front lower and upper cooling channels 11a and 11b have transverse segments that extend below and above the endcaps 2, respectively. In this embodiment the front lower and upper cooling channels 11a and 11b are formed as a branch of the lower and upper cooling channels 4a and 4b. In an alternative embodiment the front lower and upper cooling channels 11a and 11b may be channels that are independent of the lower and upper cooling channels 4a and 4b, which therefore have separate quantities of fluid flowing through them.

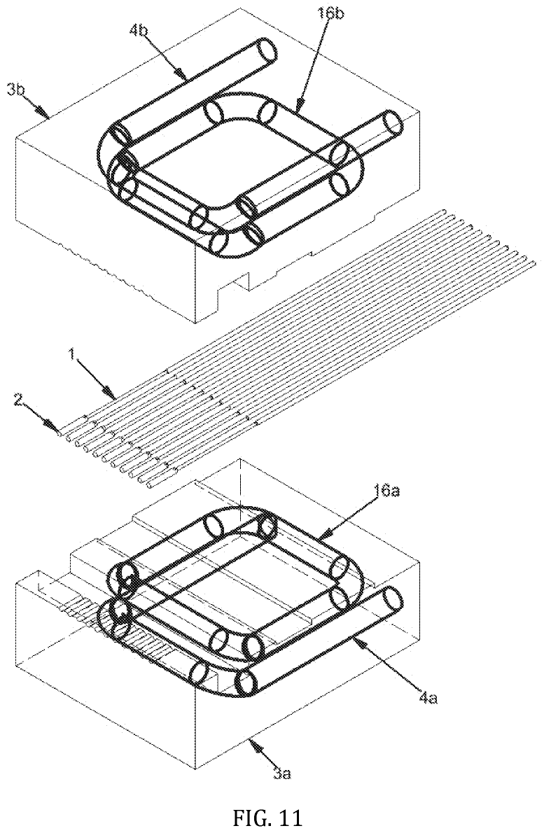

FIGS. 10-11 shows yet another embodiment of the high-power fiber array assembly in which the lower and upper cooling channels 4a and 4b each have a closed loop cooling channel associated with it. FIG. 10 shows a side view and FIG. 11 shows an exploded perspective view. As shown, the lower cooling channel 4a is associated with the lower closed loop cooling channel 16a and the upper cooling channel 4b is associated with the upper closed loop cooling channel 16b. Lower and upper closed loop cooling channels 16a and 16b are located closer to the optical fibers 2 in the radial direction relative to the lower and upper cooling channels 4a and 4b to thereby better receive energy arising from the light reflected back from the fiber endcap 2. In those embodiments employing a transparent support structure, the lower and upper closed loop cooling channels 16a and 16b may include an absorbing die to better absorb light that enters the support structure 3, which heats the fluid in the closed loop channels. As the arrows 18 in FIG. 10 indicate, the heat from the lower and upper closed loop cooling channels 16a and 16b flows to the lower and upper cooling channels 4a and 4b, respectively, where the heat is removed from the fiber array assembly by the fluid flowing therein.

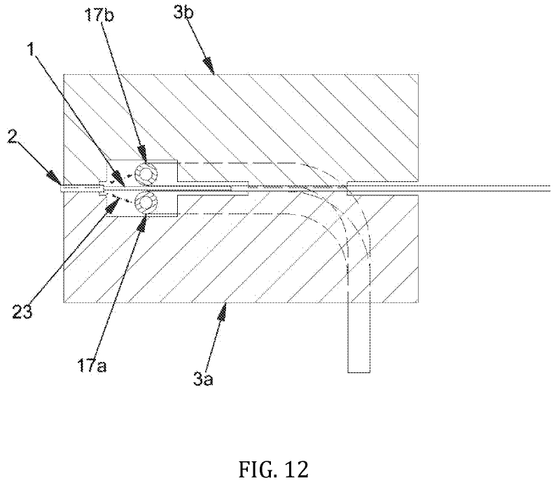

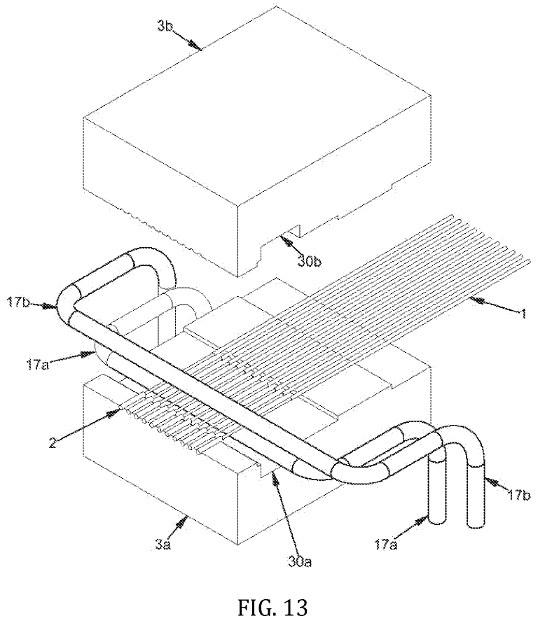

FIGS. 12 and 13 shows another embodiment of the high-power fiber array assembly in which the cooling conduits are formed from tubes 17a and 17b that extend through the support structure 3. FIG. 12 is a side view and FIG. 13 is an exploded perspective view. As shown, the tubes 17a and 17b extend through the airgap defined by the notches 30a and 30b formed in the lower and upper support structures 3a and 3b. In the example shown, the tube 17b extends in the airgap above the optical fiber array and the tube 17a extends in the airgap below the optical fiber array.

It should be noted that the various features in the illustrative embodiments described above may be combined in different embodiments that will be event to those of ordinary skill in the art. For example, in some embodiments the high-power fiber array assembly may incorporate cooling conduits formed from both channels and tubes. As another example, in some embodiments a closed loop cooling channel may be located in only one of the upper or lower support structures and the other one of the upper or lower support structures may include a front cooling channel to keep the endcap cool. More generally, the number of conduits and their particular configuration shown in the depicted embodiments are presented for illustrative purposes only and not as a limitation on the types or varieties of conduit arrangements that may be incorporated to remove heat arising from optical energy back reflected from the end caps that enters the support structure.

The foregoing description, for the purpose of explanation, has been described with reference to specific embodiments. However, the illustrative embodiments are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein but may be modified within the scope and equivalent of the appended claims.

1. An optical fiber array assembly for high power applications, comprising:
a support structure;
an optical fiber array extending through the support structure and having a plurality of optical fibers extending in a common longitudinal direction;
a plurality of end caps arranged such that each of the end caps is attached to an end portion of one of the optical fibers; and
a fluidic conduit arrangement having one or more conduits extending through the support structure, the one or more conduits being configured to support a flow of fluid therein to remove heat arising from optical energy back reflected from the end caps that enters the support structure.

2. The optical fiber array assembly of claim 1, wherein the one or more conduits includes at least one channel formed in the support structure.

3. The optical fiber array assembly of claim 1, wherein the one or more conduits includes at least one tube extending through the support structure.

4. The optical fiber array assembly of claim 1, wherein the support structure includes an airgap positioned to receive the back reflected optical energy, the one or more conduits including a first conduit having a first conduit segment that extends across the plurality of optical fibers in the optical fiber array to thereby receive the back reflected optical energy as light and/or heat that enters the support structure through a sidewall defining the airgap.

5. The optical fiber array assembly of claim 4, wherein the first conduit segment extends across the plurality of optical fibers on a first side of the optical fiber array and further comprising a second conduit having a second conduit segment extending across the plurality of optical fibers on a second side of the optical fibers opposing the first side of the optical fiber array.

6. The optical fiber array assembly of claim 5, wherein the first and second conduits each have an input and output through which the fluid enters and exits, respectively.

7. The optical fiber array assembly of claim 4, wherein the sidewall of the airgap has an absorbent coating that absorbs the back reflected optical energy.

8. The optical fiber array assembly of claim 1, wherein the support structure is transparent to the back reflected optical energy and the fluid flowing in the one or more conduits includes an absorbing die that absorbs the back reflected optical energy.

9. The optical fiber array assembly of claim 4, further comprising a third conduit segment that extends across the plurality of end caps to remove optical energy back reflected from the end caps that enters the support structure from circumferential sidewalls of the end caps.

10. The optical fiber array assembly of claim 4, further comprising a closed loop conduit containing a fluid having an absorbing die therein that absorbs the back reflected optical energy, the closed loop conduit being located radially closer to the optical fibers than the first conduit such that heat absorbed by the closed loop conduit flows through the support structure to the first conduit.

11. The optical fiber array assembly of claim 1, wherein the support structure includes upper and lower support structures that mate with one another with the optical fiber array being located therebetween, the upper and lower support structures each including a corresponding notch that defines the airgap when the upper and lower support structures are mated to one another.

12. The optical fiber array assembly of claim 11, wherein the one or more conduits includes first and second conduits extending in the upper and lower support structure, respectively, the first and second conduits being arranged symmetrically with respect to one another about a mating surface where the upper and lower support structures meet.
